(19) United States
(12) Patent Application Publication
(10) Pub. No.: US 2017/0098879 A1
(43) Pub. Date: Apr. 6, 2017

(54) DIFFERENTIAL SIGNAL TRANSMISSION LINE

(71) Applicant: FUJITSU LIMITED, Kawasaki-shi (JP)

(72) Inventor: Yasuo HIDAKA, Cupertino, CA (US)

(21) Appl. No.: 14/873,061

(22) Filed: Oct. 1, 2015

(51) Int. Cl. H01P 3/02; H01P 11/00

(52) U.S. Cl. CPC H01P 3/02; H01P 11/001

(57) ABSTRACT

A differential signal transmission line may include first, second, and third conductors and first and second insulative materials. The first and second conductors may be configured to carry positive and negative signals of a differential signal. The first insulative material may be positioned between the first conductor and the second conductor and may have an effect on a differential mode dielectric constant of the differential signal that is greater than an effect on a common mode dielectric constant of the differential signal. The second insulative material may be positioned to electrically isolate the third conductor from the first conductor, the second conductor, and the first insulative material and may have an effect on the differential mode dielectric constant of the differential signal that is lower than an effect on the common mode dielectric constant of the differential signal.

### FIELD

The embodiments discussed in the present disclosure are related to a differential signal transmission line.

### BACKGROUND

Transmission lines may be configured to carry signals between different electrical circuits or components. For example, a transmission line may carry a signal between two different servers or other components in a networked configuration. In some circumstances, a transmission line may carry a differential signal. A differential signal may typically include two separate signals that are sent along two different signal conductors. Information is read from and written to a differential signal based on comparisons between the two separate signals. The two signals in a differential signal, however, may not propagate at the same speed due to non-uniformities in the materials surrounding the traces or the traces themselves, among other reasons, which may cause intra-pair skew between the two signals of the differential signal. Intra-pair skew may result in degradation and/or loss of a differential signal.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a differential signal transmission line may include a first, second, and third conductors and first and second insulative materials. The first conductor may be configured to carry a positive signal of a differential signal. The second conductor may be configured to carry a negative signal of the differential signal. The first insulative material may be positioned between the first conductor and the second conductor. The first insulative material may have an effect on a differential mode dielectric constant of the differential signal that is greater than an effect on a common mode dielectric constant of the differential signal.

The second insulative material may be positioned to electrically isolate the third conductor from the first conductor, the second conductor, and the first insulative material. The second insulative material may have an effect on the common mode dielectric constant of the differential signal that is greater an effect on the differential mode dielectric constant of the differential signal.

The objects and advantages of the embodiments will be realized and achieved at least by the elements, features, and combinations particularly pointed out in the claims.

It is to be understood that both the foregoing general description and the following detailed description are given as examples, are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1a illustrates a cross section of an example differential signal transmission line;

FIG. 1b illustrates another cross section of the example differential signal transmission line of FIG. 1a;

FIG. 1c illustrates a plot of example single-end pulse responses along the example differential signal transmission line of FIG. 1b;

FIG. 1d illustrates a plot of example mixed-mode pulse responses along the example differential signal transmission line of FIG. 1b;

FIG. 1e illustrates a plot of an example frequency response of a differential signal along the example differential signal transmission line of FIG. 1b;

FIG. 2 illustrates a cross section of another example differential signal transmission line;

FIG. 3 illustrates a cross section of another example differential signal transmission line;

FIG. 4 illustrates a cross section of another example differential signal transmission line; and

FIG. 5 is a flowchart of an example method to form a differential signal transmission line.

### DESCRIPTION OF EMBODIMENTS

As explained in detail below, a transmission line may be configured to compensate for mode conversions that may be experienced by a differential signal carried by the transmission line. Mode conversions of a differential signal may occur when the differential signal converts from a differential mode to a common mode or vice versa. Mode conversion may result in differential signal power insertion loss and thus signal degradation. In some circumstances, mode conversion may limit an operating frequency of the differential signal.

In some circumstances, intra-pair skew between two signals of the differential signal may result in mode conversions of a differential signal. Intra-pair skew may be caused by the two signals of a differential signal propagating at different speeds. For example, when two signals of a differential signal propagate at significantly different speeds, they may become out of phase with each other such that the differential signal may change modes, e.g., changing from a differential mode to a common mode. Mode conversion caused by intra-pair skew typically increases as the frequencies of differential signals are increased.

According to some embodiments described in the present disclosure, a transmission line is configured to reduce mode conversions of a differential signal carried by the transmission line. In some embodiments, the transmission line may be configured to reduce mode conversions by increasing an inter-mode skew between differential mode and common mode of the differential signal pair. In some embodiments, the transmission line may be configured to increase an inter-mode skew by having a first dielectric constant of a first material in the transmission line may be different than a second dielectric constant of a second material in the transmission line.

The first material in the transmission line may be configured such that the first dielectric constant of the first material has a primary effect on a differential mode dielectric constant of the differential signal and a minor effect on a common mode dielectric constant of the differential signal. The first material may be positioned to electrically isolate a first conductor from a second conductor in the transmission line, where the first and second conductors are configured to carry a differential signal.

The second material in the transmission line may be configured such that the second dielectric constant of the second material has a primary effect on the common mode dielectric constant of the differential signal and a minor effect on the differential mode dielectric constant of the differential signal. The second material may be positioned in the transmission line to electrically isolate the first and second conductors from other conductors in the transmission line, such as other differential signal conductors, ground conductors, and shielding conductors. Maintaining the difference between the common mode dielectric constant of the differential signal and the differential mode dielectric constant of the differential signal by maintaining the difference between the second dielectric constant of the second material and the first dielectric constant of the first material may result in an increase of inter-mode skew and thus a reduction of mode-conversion.

In some embodiments, the mode-conversion reduction may be maintained over wide frequency ranges of the differential signal such that the data rate of the differential signal may be increased for the transmission line as compared to other transmission lines that do not incorporate one or more of the concepts described in this disclosure.

Embodiments of the present disclosure are now explained with reference to the accompanying drawings.

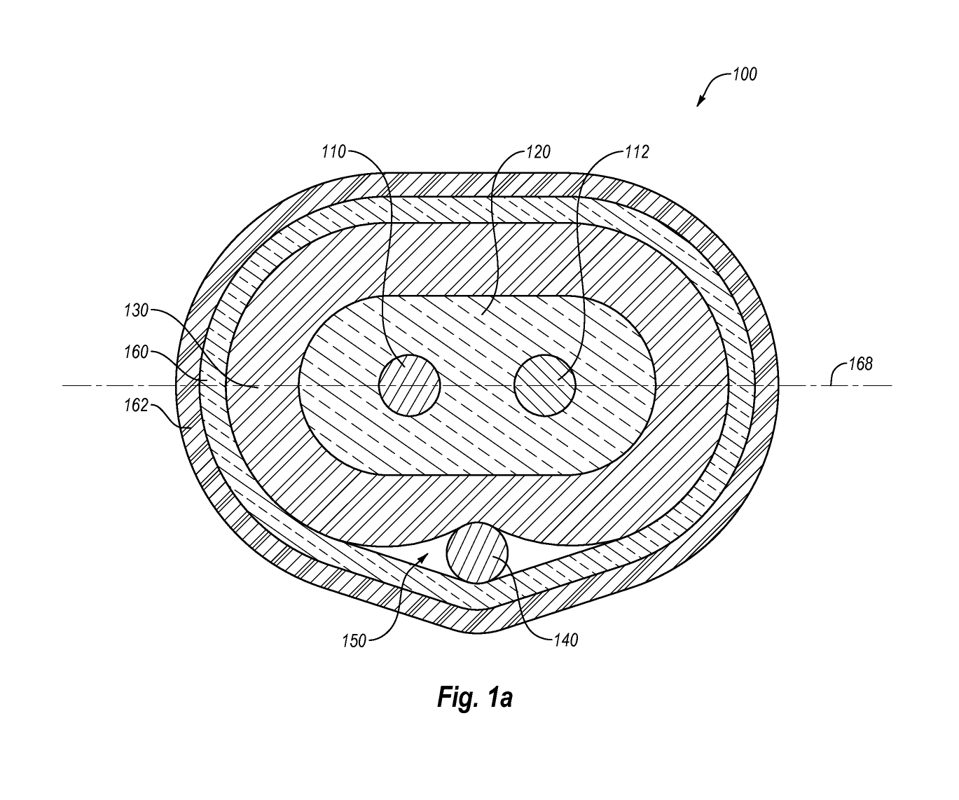

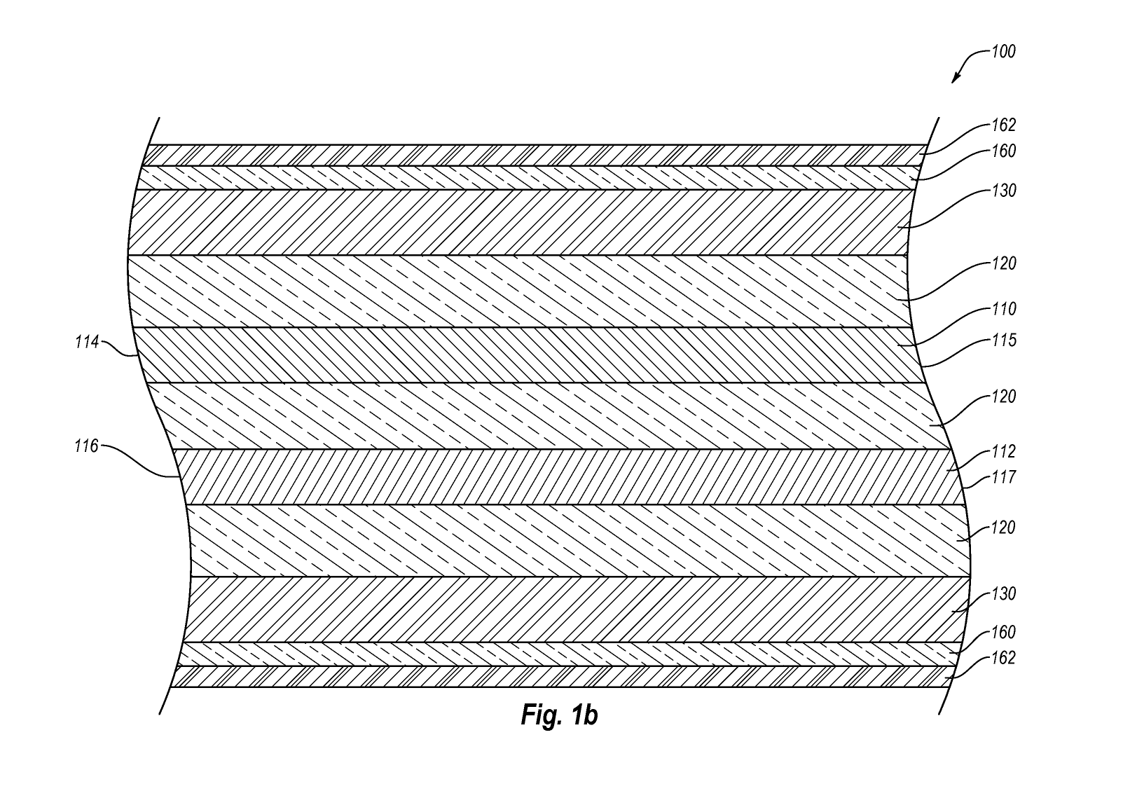

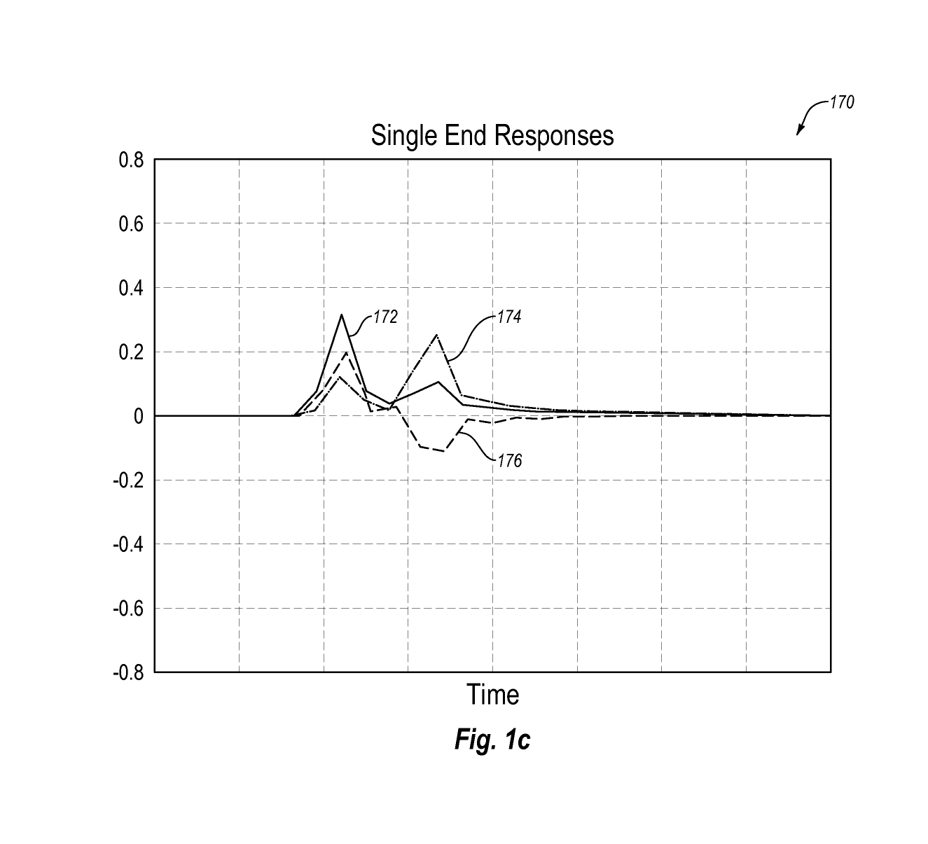

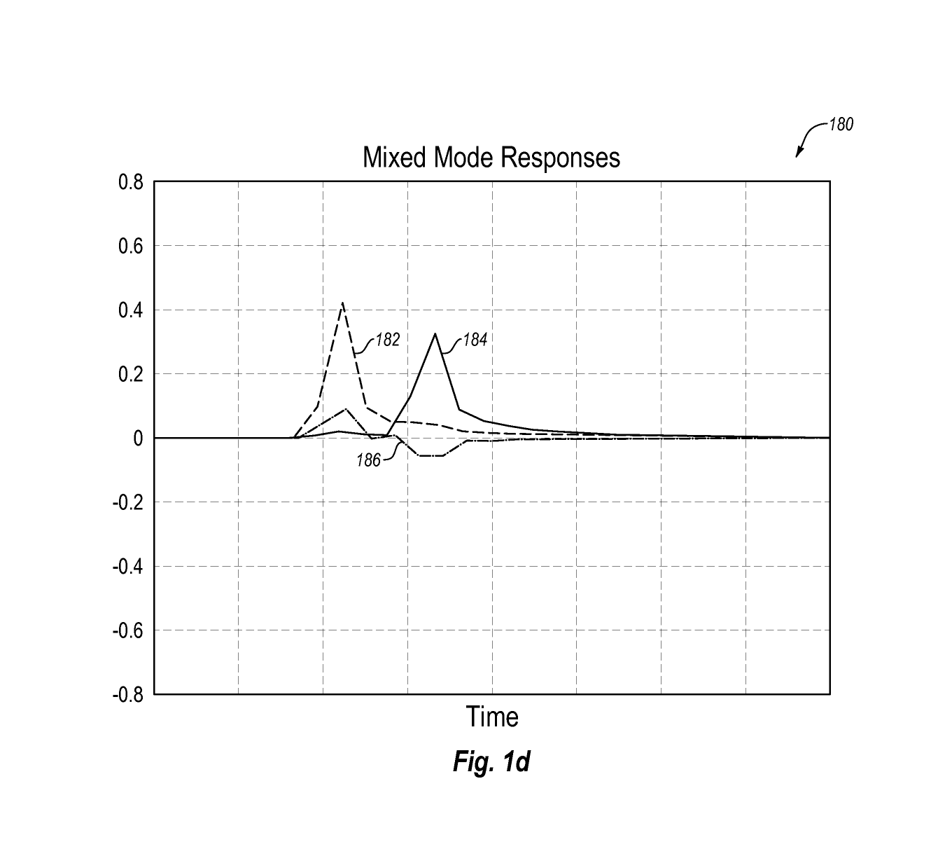

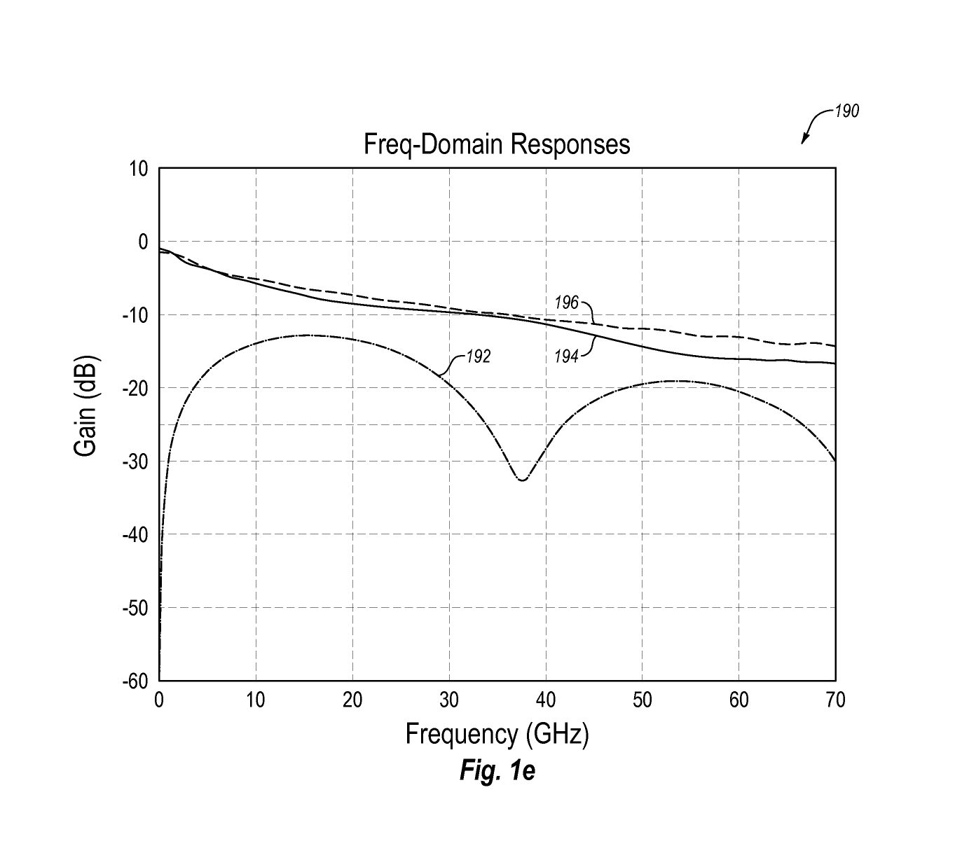

FIG. 1a illustrates a cross section of an example differential signal transmission line 100 (“the line 100”), according to at least one embodiment of the present disclosure. The cross-section illustrated in FIG. 1a may be in a plane that is perpendicular to a direction in which the line 100 extends. Thus, as illustrated, the line 100 may extend either into or out of the FIG. 1a, or both into and out of FIG. 1a. The line 100 may have a cross section as illustrated along the entirety of the line 100 or along a portion of the line 100, such as a straight portion between connectors. Thus, a width of the line 100 may be illustrated in FIG. 1a, but a length of the line may not be illustrated in FIG. 1a.

The line 100 may include a first conductor 110, a second conductor 112, a first insulative material 120, a second insulative material 130, a third conductor 140, a fourth conductor 160, and a third insulative material 162.

The first conductor 110 and the second conductor 112 may be any suitable type of conductor configured to carry an electric current. In some embodiments, the first conductor 110 and the second conductor 112 may be configured to carry a differential signal. In these and other embodiments, the first conductor 110 may be configured to carry a first signal of a differential signal and the second conductor 112 may be configured to carry a second signal of the differential signal. In these and other embodiments, either of the first signal or the second signal may be the positive or negative signal of the differential signal.

The first conductor 110 and the second conductor 112 may be positioned in relation with each other to facilitate the carrying of a differential signal. For example, in some embodiments, the first conductor 110 and the second conductor 112 may be in parallel along at least a portion of the length of the line 100. In these and other embodiments, the first conductor 110 and the second conductor 112 may be in parallel with an approximately equal distance between the first conductor 110 and the second conductor 112 along at least a portion of the length of the line 100.

The first insulative material 120 may be positioned between the first conductor 110 and the second conductor 112. In some embodiments, the first insulative material 120 may be positioned to electrically isolate the first conductor 110 from the second conductor 112. In these and other embodiments, the first insulative material 120 may be positioned such that the first insulative material 120 completely fills the space along a plane that intersects the middle of the first conductor 110 and the second conductor 112. In some embodiments, the first insulative material 120 may fill a space that covers a majority of electric field fluxes between the first conductor 110 and the second conductor 112. As illustrated, the first insulative material 120 may completely surround the first conductor 110 and the second conductor 112 such that the first insulative material 120 encapsulates the first conductor 110 and the second conductor 112.

The first insulative material 120 may be any insulative material that is configured to insulate conductors that include a dielectric constant higher than air. In some embodiments, the first insulative material 120 may have a first dielectric constant. In these and other embodiments, the first insulative material 120 may be configured such that the first dielectric constant may have an effect on a differential mode dielectric constant (“a DM dielectric constant”) of the differential signal. The first insulative material 120 may also be configured such that the first dielectric constant may have an effect on a common mode dielectric constant (“a CM dielectric constant”) of the differential signal.

In general, a differential signal propagating along the first conductor 110 and the second conductor 112 in a differential mode indicates that current is flowing in different directions in the first conductor 110 and the second conductor 112. For example, current may be flowing into the page along the first conductor 110 and out of the page along the second conductor 112. In these and other embodiments, in the differential mode a return current of the signal of the first conductor 110 may flow along the second conductor 112.

In general, a differential signal propagating along the first conductor 110 and the second conductor 112 in a common mode indicates that current is flowing in the same direction in the first conductor 110 and the second conductor 112. In these and other embodiments, in the common mode a return current of the signal of the first conductor 110 and the second conductor 112 may flow along a different conductor than the first conductor 110 and the second conductor 112. For example, the return current may flow along the third conductor 140.

In these and other embodiments, the effect of the first dielectric constant of the first insulative material on the DM dielectric constant may be a primary effect and may be higher than the effect of the first dielectric constant of the first insulative material on the CM dielectric constant, which may be a minor effect. The first insulative material 120 may be configured to have the primary effect on the DM dielectric constant and the minor effect on the CM dielectric constant based on the material used in the first insulative material 120 and the cross-sectional shape of the first insulative material 120 with respect to the first conductor 110 and the second conductor 112.

The second insulative material 130 may be positioned between, such as surrounding, the first conductor 110 and the second conductor 112 to electrically isolate the first conductor 110 and the second conductor 112 from the third conductor 140 and/or the fourth conductor 160. In some embodiments, the second insulative material 130 may be configured to completely surround the first insulative material 120. In these and other embodiments, the second insulative material 130 may encapsulate the first insulative material 120.

The second insulative material 130 may be any insulative material that is configured to insulate conductors that include a dielectric constant higher than air. In some embodiments, the second insulative material 130 may have a second dielectric constant. In these and other embodiments, the second insulative material 130 may be configured such that the second dielectric constant may have an effect on the DM dielectric constant of the differential signal. The second insulative material 130 may also be configured such that the second dielectric constant may have an effect on the CM dielectric constant of the differential signal.

In these and other embodiments, the effect of the second dielectric constant of the second insulative material 130 on the DM dielectric constant may be minor and thus less than the effect of the second dielectric constant of the second insulative material 130 on the CM dielectric constant, which may be a primary effect. The second insulative material 130 may be configured to have the minor effect on the DM dielectric constant and the primary effect on the CM dielectric constant based on the material used in the second insulative material 130, the material used in the first insulative material 120, and the cross-sectional shape of the second insulative material 130 with respect to the first insulative material 120, the first conductor 110, the second conductor 112, the third conductor 140, and the fourth conductor 160.

As used herein, the DM dielectric constant of the differential signal may indicate the dielectric constant experienced by the differential signal when traversing the first conductor 110 and the second conductor 112 in the differential mode. Note that the DM dielectric constant of the differential signal may not be equal to either of the first or second dielectric constants of the first and second insulative materials 120 and 130. Rather, the DM dielectric constant of the differential signal may be based on how the first dielectric constant of the first insulative material 120, the second dielectric constant of the second insulative material 130, and the cross-sectional shape of the line 100 interact to affect the propagation of the differential signal when traversing the first conductor 110 and the second conductor 112 in the differential mode.

As used herein, the CM dielectric constant of the differential signal may indicate the dielectric constant experienced by the differential signal when traversing the first conductor 110 and the second conductor 112 in the common mode. Note that the CM dielectric constant of the differential signal may not be equal to either of the first or second dielectric constants of the first and second insulative materials 120 and 130. Rather, the CM dielectric constant of the differential signal may be based on how the first dielectric constant of the first insulative material 120, the second dielectric constant of the second insulative material 130, and the cross-sectional shape of the line 100 interact to affect the propagation of the differential signal when traversing the first conductor 110 and the second conductor 112 in the common mode.

In some embodiments, the first dielectric constant of the first insulative material 120, the second dielectric constant of the second insulative material 130, and the cross-sectional shape of the line 100 may be selected such that the DM dielectric constant may be different than the CM dielectric constant. When the DM dielectric constant is different than the CM dielectric constant, then an increase in coupling, either inductive or capacitive, between the first conductor 110 and the second conductor 112 may occur.

In these and other embodiments, when the first dielectric constant of the first insulative material 120 is greater than the second dielectric constant of the second insulative material 130, then the DM dielectric constant may be greater than the CM dielectric constant. When the DM dielectric constant is greater than the CM dielectric constant, then the first conductor 110 and the second conductor 112 may be capacitively coupled. When the first dielectric constant of the first insulative material 120 is less than the second dielectric constant of the second insulative material 130, then the DM dielectric constant may be less than the CM dielectric constant. When the DM dielectric constant is less than the CM dielectric constant, then the first conductor 110 and the second conductor 112 may be inductively coupled.

An increase in the coupling between the first conductor 110 and the second conductor 112 may result in an increase in an inter-mode skew of a differential signal that propagates along the first conductor 110 and the second conductor 112. The inter-mode skew of the differential signal may refer to a difference in propagation time of the differential signal when propagating in a differential mode and in a common mode. Thus, the increase in the inter-mode skew indicates that the time difference increases between the propagation time of the differential signal when propagating in the differential mode and in the common mode.

In some embodiments, the increase in coupling between the first conductor 110 and the second conductor 112, and thus the increase in the inter-mode skew of the differential signal propagating along the first conductor 110 and the second conductor 112 may reduce mode-conversion of the differential signal. In general, mode-conversion of the differential signal refers to the differential signal changing from a first mode when transmitted to a second mode during propagation. For example, the differential signal may change from a differential mode to a common mode during propagation of the differential signal.

Additionally, an increase in coupling between the first conductor 110 and the second conductor 112 due to the values of the DM dielectric constant and the CM dielectric constant as described in this disclosure may result in an increase in an intra-pair skew of a differential signal that propagates along the first conductor 110 and the second conductor 112. An intra-pair skew of a differential signal may refer to a difference in propagation time between a first signal of the differential signal traversing the first conductor 110 and a second signal of the differential signal traversing the second conductor 112.

Note that without an increase in coupling between the first conductor 110 and the second conductor 112, the increase in intra-pair skew may result in an increase in mode-conversion of a differential signal in the line 100. Thus, other differential signal lines are typically constructed to reduce intra-pair skew. In contrast, the line 100 is configured to increase coupling, which leads to increased inter-mode skew and intra-pair skew, but reduces mode-conversion of a differential signal in the line 100. Plots 170, 180, and 190 of FIGS. 1c, 1d, and 1e, illustrate the increased inter-mode skew, intra-pair skew, and reduced mode-conversion of a differential signal in the line 100.

The third conductor 140 may be any suitable type of conductor configured to carry an electrical current. In some embodiments, the third conductor 140 may be a ground drain conductor configured to couple ground signals of circuits coupled by the line 100.

The fourth conductor 160 may be any suitable type of conductor configured to carry an electrical current. The fourth conductor 160 may be configured to completely surround the second insulative material 130 to encapsulate the second insulative material 130 and the third conductor 140. In some embodiments, the fourth conductor 160 may be a ground shield conductor configured to shield the first conductor 110 and the second conductor 112 from electrical and magnetic interference.

As illustrated, the second insulative material 130 may be positioned between the first insulative material 120 and the fourth conductor 160. In some embodiments, air pockets 150 may surround a portion of the third conductor 140. Alternately or additionally, a portion of the third conductor 140 may be in contact with the fourth conductor 160 and the remaining portion of the third conductor 140 may be in contact with the second insulative material 130.

The third insulative material 162 may be any suitable type of insulative material and/or protective material to coat the line 100. In these and other embodiments, the third insulative material 162 may completely surround the fourth conductor 160 to encapsulate the fourth conductor 160.

Modifications, additions, or omissions may be made to FIG. 1a without departing from the scope of the present disclosure. For example, in some embodiments the line 100 may not include the third conductor 140. In these and other embodiments, when air or another insulative material surrounds the second insulative material 120, the DM dielectric constant and the CM dielectric constant may be based on how the first dielectric constant of the first insulative material 120, the second dielectric constant of the second insulative material 130, the cross-sectional shape of the line 100, and the other insulative material interact to affect the propagation of the differential signal when traversing the first conductor 110 and the second conductor 112. In these and other embodiments, the first dielectric constant and the second dielectric constant may be the same, but the difference in the dielectric constant of the other insulative material may result in a difference between the DM dielectric constant and the CM dielectric constant.

Alternately or additionally, the line 100 may not include the fourth conductor 160. Alternately or additionally, the cross-sectional shape of the first insulative material 120 may be different than the shape illustrated in FIG. 1a.

FIG. 1b illustrates another cross section of the line 100 of FIG. 1a, according to at least one embodiment described in the present disclosure. The cross-section illustrated in FIG. 1b may be in a plane that is parallel to a direction in which the line 100 extends. With respect to FIG. 1a, the cross-section illustrated in FIG. 1b may be taken along the line 168 illustrated in FIG. 1a. The line 100 may have a cross section as illustrated along the entirety of the line 100 or along a portion of the line 100, such as a straight portion between connectors, turns, and/or joints.

As illustrated in FIG. 1b, the first conductor 110 may include a first end 114 and a second end 115. The second conductor 112 may include a third end 116 and a fourth end 117. FIGS. 1c and 1d may illustrate signals that propagate along the first conductor 110, the second conductor 112, the first insulative material 120, and the second insulative material 130 from the first end 114 and the third end 116 to the second end 115 and the fourth end 117, respectively.

FIG. 1c illustrates a plot 170 of an example single-end pulse response along the line 100 of FIG. 1b, according to at least one embodiment described in the present disclosure. The plot 170 includes an x-axis that represents time and a y-axis that represents voltage. A graph line 172 may represent a voltage of a signal over time at the second end 115 of the first conductor 110 when the signal is provided at the first end 114 of the first conductor 110. A graph line 174 may represent a voltage of a signal over time at the fourth end 117 of the second conductor 112 when the signal is provided at the third end 116 of the second conductor 112. The difference between the peaks of the graph line 172 and the graph line 174 may represent intra-pair skew between signals of a differential signal provided to the first conductor 110 and the second conductor 112. In the line 100 of FIGS. 1a and 1b as described, the intra-pair skew may be larger than in other differential signal transmission lines.

A graph line 176 illustrates coupling between the first conductor 110 and the second conductor 112. The graph line 176 may represent voltages on the second end 115 of the first conductor 110 and the fourth end 117 of the second conductor 112 based on signals provided at the other ends of the first conductor 110 and the second conductor 112. For example, a signal provided at the first end 114 of the first conductor 110 may result in a voltage on the fourth end 117 of the second conductor 112 based on the coupling between the first conductor 110 and the second conductor 112 as illustrated by the graph line 176. A signal provided at the third end 116 of the second conductor 112 may also result in a voltage on the second end 115 of the first conductor 110 as illustrated by the graph line 176. In these and other embodiments, the spikes of the graph line 176 may be higher in the line 100 than in other differential signal transmission lines because of the increased coupling between the first conductor 110 and the second conductor 112 in the line 100.

FIG. 1d illustrates a plot 180 of an example mixed-mode pulse response along the line 100 of FIG. 1b, according to at least one embodiment described in the present disclosure. The plot 180 includes an x-axis that represents time and a y-axis that represents voltage. A graph line 182 may represent a voltage of a differential signal in common mode over time at the second end 115 of the first conductor 110 and the fourth end 117 of the second conductor 112 when a differential signal in common mode is provided at the first end 114 of the first conductor 110 and the third end 116 of the second conductor 112 and the differential signal propagates in the common mode. A graph line 184 may represent a voltage of a differential signal in differential mode over time at the second end 115 of the first conductor 110 and the fourth end 117 of the second conductor 112 when a differential signal in differential mode is provided at the first end 114 of the first conductor 110 and the third end 116 of the second conductor 112 and the differential signal propagates in the differential mode.

A difference between the peaks of the graph line 182 and the graph line 184 may represent inter-mode skew between the differential signal propagating in the common mode and in the differential mode. A graph line 186 represents a voltage of a differential signal in common mode over time at the second end 115 of the first conductor 110 and the fourth end 117 of the second conductor 112 when a differential signal in differential mode is provided at the first end 114 of the first conductor 110 and the third end 116 of the second conductor 112 and the differential signal is converted from the differential mode to the common mode while propagating. A height of the peak of the graph line 186 may represent mode conversion of the differential signal from the differential mode to the common mode. In the line 100 of FIGS. 1a and 1b as described, the inter-mode skew may be larger than in other differential signal transmission lines, and thus the mode conversion may be less than in other differential signal transmission lines.

FIG. 1e illustrates a plot 190 of an example frequency response of a differential signal along the line 100 of FIG. 1b, according to at least one embodiment described in the present disclosure. The plot 190 includes an x-axis that represents a frequency of a signal and a y-axis that represents a gain of a signal. A graph line 196 may represent an ideal frequency response of a differential signal in differential mode at the second end 115 of the first conductor 110 and the fourth end 117 of the second conductor 112 when a differential signal in differential mode is provided at the first end 114 of the first conductor 110 and the third end 116 of the second conductor 112 and the differential signal does not have a mode conversion and propagates the entire distance in the differential mode. A graph line 194 may represent an actual frequency response of a differential signal in differential mode at the second end 115 of the first conductor 110 and the fourth end 117 of the second conductor 112 when a differential signal in differential mode is provided at the first end 114 of the first conductor 110 and the third end 116 of the second conductor 112 and the differential signal has some mode conversion and propagates the entire distance in the differential mode with some additional loss in the differential mode. A graph line 192 may represent an actual frequency response of a differential signal in common mode at the second end 115 of the first conductor 110 and the fourth end 117 of the second conductor 112 when a differential signal in differential mode is provided at the first end 114 of the first conductor 110 and the third end 116 of the second conductor 112 and the differential signal undergoes a mode conversion and changes from a differential mode to a common mode during propagation along line 100. A difference between the gain of the graph line 196 and the graph line 194 may be a power loss associated with the mode conversion of the graph line 192. In some embodiments, this power loss may be referred to as an insertion loss of a line. Insertion loss of a signal may result in signal degradation. Thus, it may be preferred to avoid insertion loss. Thus, in some embodiments, the graph line 194 may be more desirable when it is as close as possible to the graph line 196, and the graph line 192 may be more desirable when it is as low as possible. The line 100 of FIGS. 1a and 1b, as discussed in this disclosure, may increase inter-mode skew and intra-pair skew by increasing coupling to thereby reduce the likelihood of mode conversion during differential signal transmission to thereby reduce insertion loss and possible signal degradation.

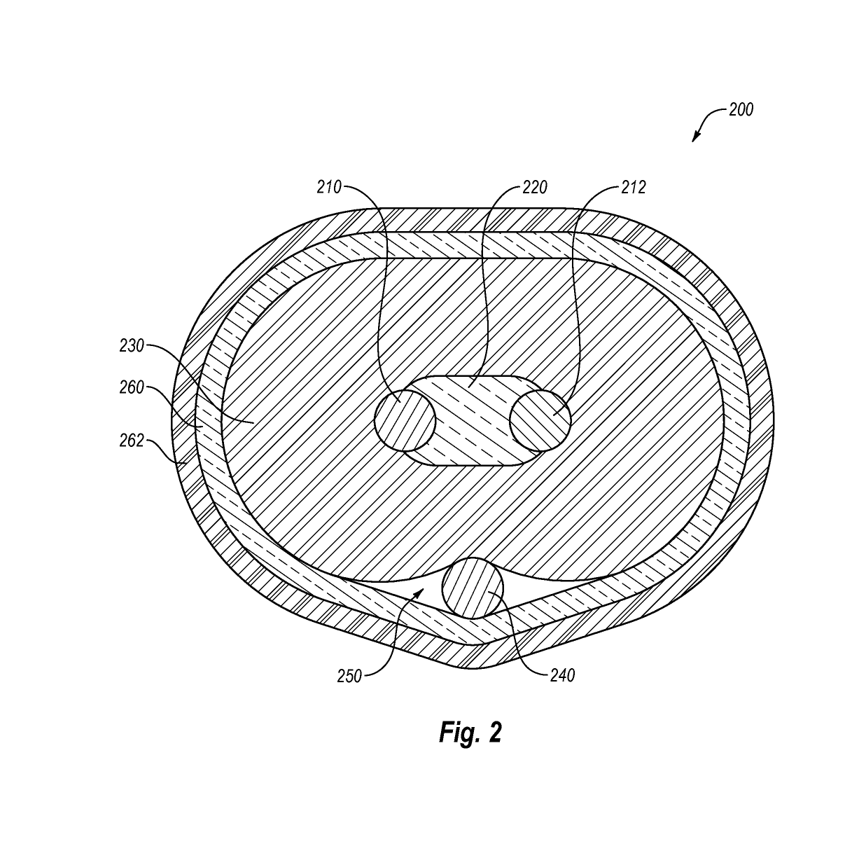

FIG. 2 illustrates a cross section of another example differential signal transmission line 200 (“the line 200”), according to at least one embodiment described in the present disclosure. The cross-section illustrated in FIG. 2 may be in a plane that is perpendicular to a direction in which the line 200 extends. Thus, as illustrated, the line 200 may extend either into or out of the FIG. 2, or both into and out of FIG. 2. The line 200 may have a cross section as illustrated along the entirety of the line 200 or along a portion of the line 200, such as a straight portion between connectors. Thus, a width of the line 200 may be illustrated in FIG. 2, but a length of the line may not be illustrated in FIG. 2.

The line 200 may include a first conductor 210, a second conductor 212, a first insulative material 220, a second insulative material 230, a third conductor 240, a fourth conductor 260, and a third insulative material 262.

The first conductor 210 and the second conductor 212 may be configured to carry signals of a differential signal. The first conductor 210 may be analogous to the first conductor 110 of the FIG. 1a. The second conductor 212 may be analogous to the second conductor 112 of the FIG. 1a.

In some embodiments, the first insulative material 220 may be analogous to the first insulative material 120 of FIG. 1a. In these and other embodiments, the first insulative material 220 may be positioned between the first conductor 210 and the second conductor 212 to electrically isolate the first conductor 210 from the second conductor 212. In these and other embodiments, the first insulative material 220 may be positioned such that the first insulative material 220 completely fills the space along a plane that intersects the middle of the first conductor 210 and the second conductor 212. As illustrated, the first insulative material 220 may not completely surround the first conductor 210 and the second conductor 212. In these and other embodiments, the first insulative material 220 may contact less than one hundred percent of the circumference of the first conductor 210 and the second conductor 212. In some embodiments, the first insulative material 220 may contact less than fifty percent of the circumference of the first conductor 210 and the second conductor 212. In these and other embodiments, the first insulative material 220 may not extend outside of parallel planes that are tangential to a surface of the first conductor 210 and a surface of the second conductor 212 and that are parallel to a plane that intersects a middle of both the first conductor 210 and the second conductor 212.

In some embodiments, the first insulative material 220 may be configured such that a first dielectric constant of the first insulative material 220 may have a primary effect on a differential mode dielectric constant (“a DM dielectric constant”) of the differential signal. The first insulative material 220 may also be configured such that the first dielectric constant may have a minor effect on a common mode dielectric constant (“a CM dielectric constant”) of the differential signal. In these and other embodiments, the primary effect of the first dielectric constant of the first insulative material 220 on the DM dielectric constant may be greater than the minor effect of the first dielectric constant of the first insulative material 220 on the CM dielectric constant.

In some embodiments, the second insulative material 230 may be analogous to the second insulative material 130 of FIG. 1a. In these and other embodiments, the second insulative material 230 may be positioned between, and in some embodiments, surrounding the first conductor 210 and the second conductor 212 to electrically isolate the first conductor 210 and the second conductor 212 from the third conductor 240 and/or the fourth conductor 260.

In some embodiments, the second insulative material 230 may be configured such that a second dielectric constant of the second insulative material 230 may have a minor effect on the DM dielectric constant of the differential signal. The second insulative material 230 may also be configured such that the second dielectric constant of the second insulative material 230 may have a primary effect on the CM dielectric constant of the differential signal. In these and other embodiments, the minor effect of the second dielectric constant of the second insulative material 230 on the DM dielectric constant may be less than the primary effect of the second dielectric constant of the second insulative material 230 on the CM dielectric constant.

In some embodiments, the first dielectric constant of the first insulative material 220 may be different than the second dielectric constant of the second insulative material 230 such that the DM dielectric constant of the differential signal may be different than the CM dielectric constant of the differential signal. The configuration of the first insulative material 220 and the second insulative material 230 may result in increased inter-mode skew of the differential signal that propagates along the first conductor 210 and the second conductor 212 and increased coupling between the first conductor 210 and the second conductor 212.

In some embodiments, the value of the DM dielectric constant may be different than the value of the CM dielectric constant by a magnitude more than a multiple of an average variation of the DM dielectric constant, the CM dielectric constant, or the greater variation of the CM dielectric constant and the DM dielectric constant. For example, in some embodiments, the first insulative material 220 and/or the second insulative material 230 may have variations in their material or structure. The first dielectric constant may vary within the area of the first insulative material 220 and the second dielectric constant may vary within the area of the second insulative material 230. The cross-sectional shapes of the first insulative material 220 and/or the second insulative material 230 may vary with respect to the first conductor 210, the second conductor 220, the third conductor 240, and/or the fourth conductor 260 may vary in cross-sectional shapes. When the cross-sectional shapes of the first insulative material 220 and/or the second insulative material 230 may vary, the primary effect of the first dielectric constant on the DM dielectric constant, the minor effect of the first dielectric constant on the CM dielectric constant, the primary effect of the second dielectric constant on the CM dielectric constant, and/or the minor effect of the second dielectric constant on the DM dielectric constant may vary. Thus, when the first insulative material 220 and/or the second insulative material 230 may have variations in their material or structure, the DM dielectric constant and/or the CM dielectric constant may have variation.

In these and other embodiments, the DM dielectric constant and the CM dielectric constant of the differential signal may have a typical amount of variation. In these and other embodiments, to help to ensure a difference between the DM dielectric constant and the CM dielectric constant, the difference between the DM dielectric constant and the CM dielectric constant may be 1, 2, 3, 4, 5, 6, or a greater number of times of the typical variation in either of the DM dielectric constant or the CM dielectric constant. In some embodiments, the difference between the DM dielectric constant and the CM dielectric constant may be 1, 2, 3, 4, 5, 6, or a greater number of times of the greater of the variations of the DM dielectric constant and the CM dielectric constant. For example, if the DM dielectric constant has a typical variation of 0.03 and the CM dielectric constant has a typical variation of 0.04, the difference between the DM dielectric constant and the CM dielectric constant may be 1, 2, 3, 4, 5, 6, or a greater number of times of 0.04. For example, the difference between the DM dielectric constant and the CM dielectric constant may be 0.04, 0.08, 0.12, 0.16, 0.20, 0.24, or some greater number. Causing the difference between the DM dielectric constant and the CM dielectric constant to be bigger than typical variations of the DM dielectric constant and the CM dielectric constant may help to reduce the likelihood of the line 200 not including a sufficient difference between the DM dielectric constant and the CM dielectric constant.

The third conductor 240 and the fourth conductor 260 may be analogous to the third conductor 140 and the fourth conductor 160, respectively, of FIG. 1a. As illustrated, the second insulative material 230 may be positioned surrounding, and thus between, the first conductor 210, the second conductor 212, and the first insulative material 220 to electrically isolate the first conductor 210, the second conductor 212, and the first insulative material 220 from the third conductor 240 and/or the fourth conductor 260. In some embodiments, air pockets 250 may surround a portion of the third conductor 240. The third insulative material 262 may be analogous to the third insulative material 162 of FIG. 1a. In these and other embodiments, the third insulative material 262 may completely surround the fourth conductor 260 to encapsulate the fourth conductor 260.

Modifications, additions, or omissions may be made to FIG. 2 without departing from the scope of the present disclosure. For example, in some embodiments the line 200 may not include the third conductor 240. Alternately or additionally, the line 200 may not include the fourth conductor 260. Alternately or additionally, the cross-sectional shape of the first insulative material 220 may be different than the shape illustrated in FIG. 2.

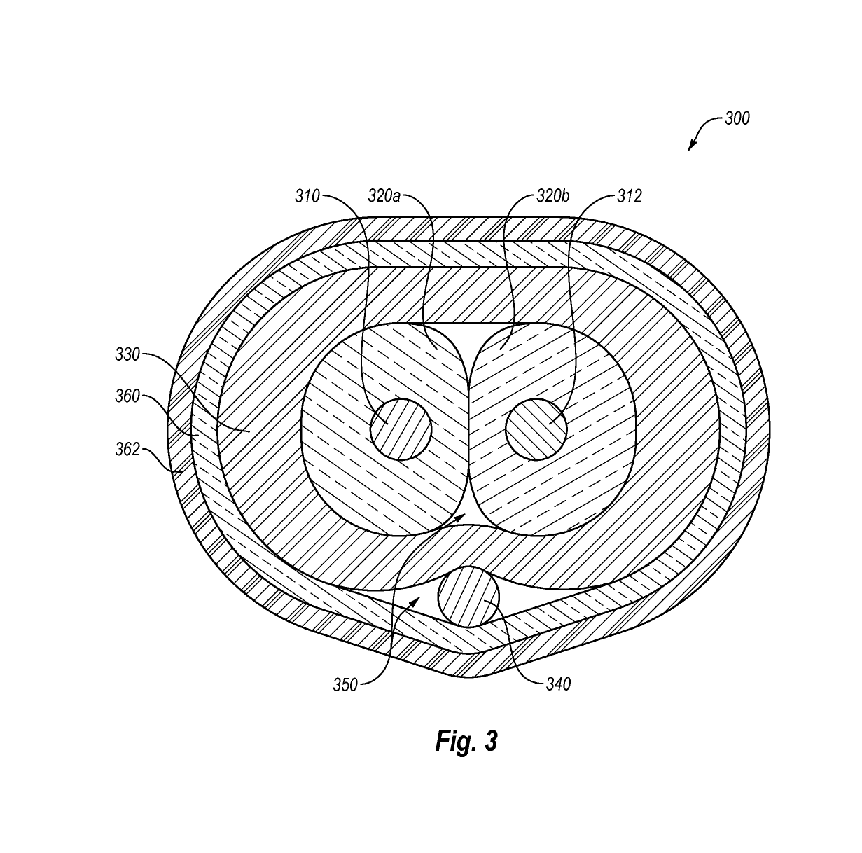

FIG. 3 illustrates a cross section of another example differential signal transmission line 300 (“the line 300”), according to at least one embodiment described in the present disclosure. The cross-section illustrated in FIG. 3 may be in a plane that is perpendicular to a direction in which the line 300 extends. Thus, as illustrated, the line 300 may extend either into or out of the FIG. 3, or both into and out of FIG. 3. The line 300 may have a cross section as illustrated along the entirety of the line 300 or along a portion of the line 300, such as a straight portion between connectors. Thus, a width of the line 300 may be illustrated in FIG. 3, but a length of the line may not be illustrated in FIG. 3.

The line 300 may include a first conductor 310, a second conductor 312, a first region 320a of a first insulative material, a second region 320b of the first insulative material, a second insulative material 330, a third conductor 340, a fourth conductor 360, and a third insulative material 362. The first region 320a and the second region 320b of the first insulative material may be referred to collectively as the first insulative material 320.

The first conductor 310 and the second conductor 312 may be configured to carry signals of a differential signal. The first conductor 310 may be analogous to the first conductor 110 of the FIG. 1a. The second conductor 312 may be analogous to the second conductor 112 of the FIG. 1a.

In some embodiments, the first conductor 310 may be surrounded by the first region 320a and the second conductor 312 may be surrounded by the second region 320b. The first region 320a and the second region 320b may be placed together such that there is a continuous region of first insulative material along a plane that intersects the middle of the first conductor 310 and the second conductor 312. In these and other embodiments, the first region 320a and the second region 320b may electrically isolate the first conductor 310 from the second conductor 312. The first insulative material of the first region 320a and the second region 320b may be analogous to the first insulative material 120 of FIG. 1a.

In some embodiments, the first insulative material in the first region 320a and the second region 320b may be configured such that a first dielectric constant of the first insulative material in the first region 320a and in the second region 320b may have a primary effect on a DM dielectric constant of the differential signal. The first insulative material 320 in the first region 320a and in the second region 320b may also be configured such that the first dielectric constant of the first insulative material in the first region 320a and in the second region 320b may have a minor effect on a CM dielectric constant of the differential signal. In these and other embodiments, the primary effect of the first dielectric constant of the first insulative material in the first region 320a and in the second region 320b on the DM dielectric constant may be higher than the minor effect of the first dielectric constant of the first insulative material in the first region 320a and in the second region 320b on the CM dielectric constant.

In some embodiments, the second insulative material 330 may be analogous to the second insulative material 130 of FIG. 1a. In these and other embodiments, the second insulative material 330 may be positioned surrounding the first conductor 310 and the second conductor 312 to electrically isolate the first conductor 310 and the second conductor 312 from the third conductor 340 and/or the fourth conductor 360. As illustrated, the second insulative material 330 may surround the first region 320a and the second region 320b. Due to the shape of the first region 320a and the second region 320b, air pockets 350 may exist between the first and second regions 320a and 320b and the second insulative material 330.

In some embodiments, the second insulative material 330 may be configured such that a second dielectric constant of the second insulative material 330 may have a minor effect on the DM dielectric constant of the differential signal. The second insulative material 330 may also be configured such that the second dielectric constant of the second insulative material 330 may have a primary effect on the CM dielectric constant of the differential signal. In these and other embodiments, the minor effect of the second dielectric constant of the second insulative material 330 on the DM dielectric constant may be less than the primary effect of the second dielectric constant of the second insulative material 330 on the CM dielectric constant. In some embodiments, the first dielectric constant of the first insulative material 320 may be different than the second dielectric constant of the second insulative material 330 such that the DM dielectric constant of the differential signal may be different than the CM dielectric constant of the differential signal. The configuration of the first insulative material 320 and the second insulative material 330 may result in increased inter-mode skew of the differential signal that propagates along the first conductor 310 and the second conductor 312 and increased coupling between the first conductor 310 and the second conductor 312.

The third conductor 340 and the fourth conductor 360 may be analogous to the third conductor 140 and the fourth conductor 160, respectively, of FIG. 1a. As illustrated, the second insulative material 330 may be positioned surrounding the first conductor 310, the second conductor 312, and the first insulative material 320 to electrically isolate the first conductor 310, the second conductor 312, and the first insulative material 320 from the third conductor 340 and/or the fourth conductor 360. In some embodiments, air pockets 350 may surround a portion of the third conductor 340. The third insulative material 362 may be analogous to the third insulative material 162 of FIG. 1a. In these and other embodiments, the third insulative material 362 may completely surround the fourth conductor 360 to encapsulate the fourth conductor 360.

Modifications, additions, or omissions may be made to FIG. 3 without departing from the scope of the present disclosure. For example, in some embodiments, the line 300 may not include the third conductor 340. Alternately or additionally, the line 300 may not include the fourth conductor 360. Alternately or additionally, the cross-sectional shape of the first insulative material 320 may be different than the shape illustrated in FIG. 3.

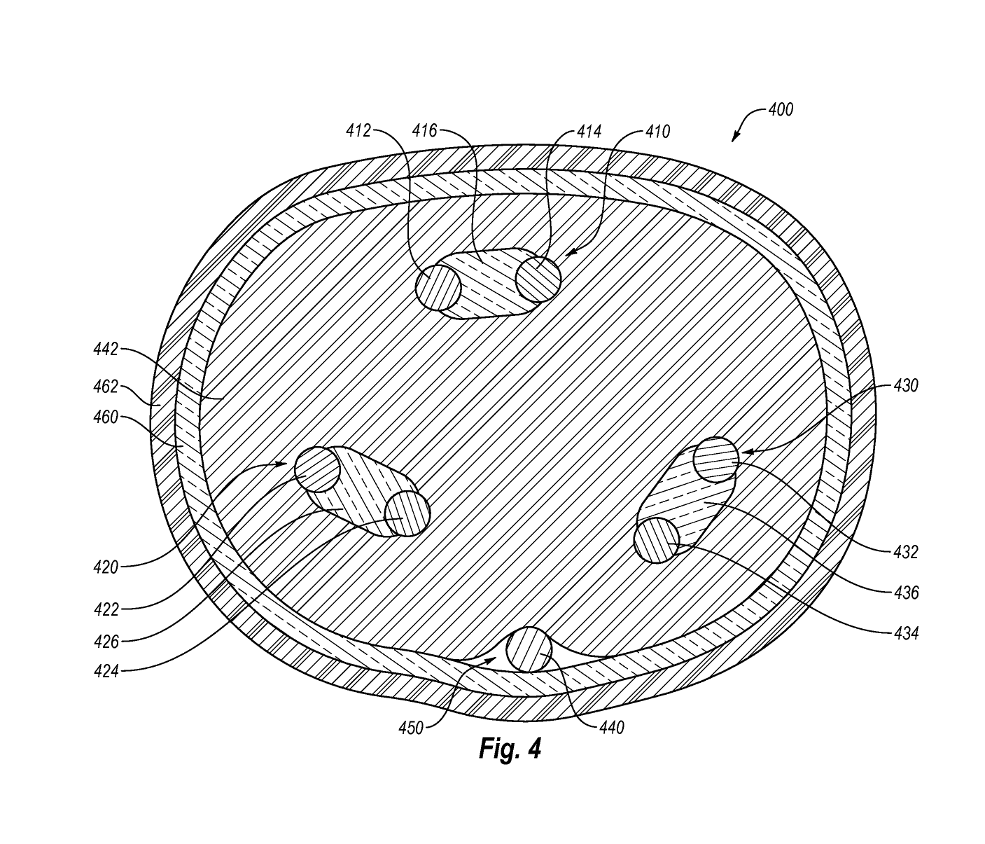

FIG. 4 illustrates a cross section of another example differential signal transmission line 400 (“the line 400”), according to at least one embodiment described in the present disclosure. The cross-section illustrated in FIG. 4 may be in a plane that is perpendicular to a direction in which the line 400 extends. Thus, as illustrated, the line 400 may extend either into or out of the FIG. 4, or both into and out of FIG. 4. The line 400 may have a cross section as illustrated along the entirety of the line 400 or along a portion of the line 400, such as a straight portion between connectors. Thus, a width of the line 400 may be illustrated in FIG. 4, but a length of the line may not be illustrated in FIG. 4.

The line 400 may include a first conductor set 410, a second conductor set 420, a third conductor set 430, a first region of first insulative material 416, a second region of first insulative material 426, a third region of first insulative material 436, a third conductor 440, a second insulative material 442, a fourth conductor 460, and a third insulative material 462.

The first conductor set 410 may include a first conductor 412 and a second conductor 414. The first conductor 412 and the second conductor 414 of the first conductor set 410 may be configured to carry signals of a differential signal. In some embodiments, the first conductor 412 and the second conductor 414 may be analogous to the first conductor 110 and the second conductor 112, respectively, of FIG. 1a. In these and other embodiments, the first region of first insulative material 416 may be positioned between the first conductor 412 and the second conductor 414 of the first conductor set 410 and may be analogous to the first insulative material 120 of FIG. 1a.

The second conductor set 420 may include a first conductor 422 and a second conductor 424. The first conductor 422 and the second conductor 424 of the second conductor set 420 may be configured to carry signals of a differential signal. In some embodiments, the first conductor 422 and the second conductor 424 may be analogous to the first conductor 110 and the second conductor 112, respectively, of FIG. 1a. In these and other embodiments, the second region of first insulative material 426 may be positioned between the first conductor 422 and the second conductor 424 of the second conductor set 420 and may be analogous to the first insulative material 120 of FIG. 1a.

The third conductor set 430 may include a first conductor 432 and a second conductor 434. The first conductor 432 and the second conductor 434 of the third conductor set 430 may be configured to carry signals of a differential signal. In some embodiments, the first conductor 432 and the second conductor 434 may be analogous to the first conductor 110 and the second conductor 112, respectively, of FIG. 1a. In these and other embodiments, the third region of first insulative material 436 may be positioned between the first conductor 432 and the second conductor 434 of the third conductor set 430 and may be analogous to the first insulative material 120 of FIG. 1a.

As illustrated, the line 400 may thus be configured to carry three differential signals simultaneously. The first conductor set 410 may be configured to carry a first differential signal, the second conductor set 420 may be configured to carry a second differential signal, and the third conductor set 430 may be configured to carry a third differential signal.

In some embodiments, each of the first region of first insulative material 416, the second region of first insulative material 426, and the third region of first insulative material 436, referred to collectively as first insulative material regions, may be configured such that a first dielectric constant of the first insulative material regions may have a primary effect on a DM dielectric constant of the differential signal. The first insulative material regions may also be configured such that the first dielectric constant of the first insulative material regions may have a minor effect on a CM dielectric constant of the differential signal. In these and other embodiments, the primary effect of the first dielectric constant of the first insulative material regions on the DM dielectric constant may be greater than the minor effect of the first insulative material regions on the CM dielectric constant.

In some embodiments, the second insulative material 442 may be analogous to the second insulative material 130 of FIG. 1a. In these and other embodiments, the second insulative material 442 may be positioned surrounding each of the first conductor set 410, the second conductor set 420, and the third conductor set 430 to electrically isolate the first conductor set 410, the second conductor set 420, and the third conductor set 430 from each other and from the third conductor 440 and/or the fourth conductor 460. In some embodiments, the second insulative material 442 may be configured to completely surround the first conductor set 410, the second conductor set 420, and the third conductor set 430 and the first insulative material regions.

In some embodiments, the second insulative material 442 may be configured such that a second dielectric constant of the second insulative material 442 may have a minor effect on the DM dielectric constant of the differential signal. The second insulative material 442 may also be configured such that the second dielectric constant of the second insulative material 442 may have a primary effect on the CM dielectric constant of the differential signal. In these and other embodiments, the minor effect of the second dielectric constant of the second insulative material 442 on the DM dielectric constant may be less than the primary effect of the second dielectric constant of the second insulative material 442 on the CM dielectric constant. In some embodiments, the first dielectric constant of the first insulative material regions may be different than the second dielectric constant of the second insulative material 442 such that the DM dielectric constant of the differential signal may be different than the CM dielectric constant of the differential signal. The configuration of the first insulative material regions and the second insulative material 442 may result in increased inter-mode skew of the differential signal that propagates along each of the first conductor set 410, the second conductor set 420, and the third conductor set 430 and increased coupling between conductors of each of the first conductor set 410, the second conductor set 420, and the third conductor set 430.

The third conductor 440 and the fourth conductor 460 may be analogous to the third conductor 140 and the fourth conductor 160, respectively, of FIG. 1a. As illustrated, the second insulative material 442 may be positioned surrounding the first conductor set 410, the second conductor set 420, and the third conductor set 430 to electrically isolate the first conductor set 410, the second conductor set 420, and the third conductor set 430 from the third conductor 440 and/or the fourth conductor 460. In some embodiments, air pockets 450 may surround a portion of the third conductor 440. The third insulative material 462 may be analogous to the third insulative material 162 of FIG. 1a. In these and other embodiments, the third insulative material 462 may completely surround the fourth conductor 460 to encapsulate the fourth conductor 460.

Modifications, additions, or omissions may be made to FIG. 4 without departing from the scope of the present disclosure. For example, in some embodiments the line 400 may not include the third conductor 440. Alternately or additionally, the line 400 may not include the fourth conductor 460. Alternately or additionally, the line 400 may include more or less conductor sets such that the line 400 may be configured to carry more or less than three differential signals simultaneously.

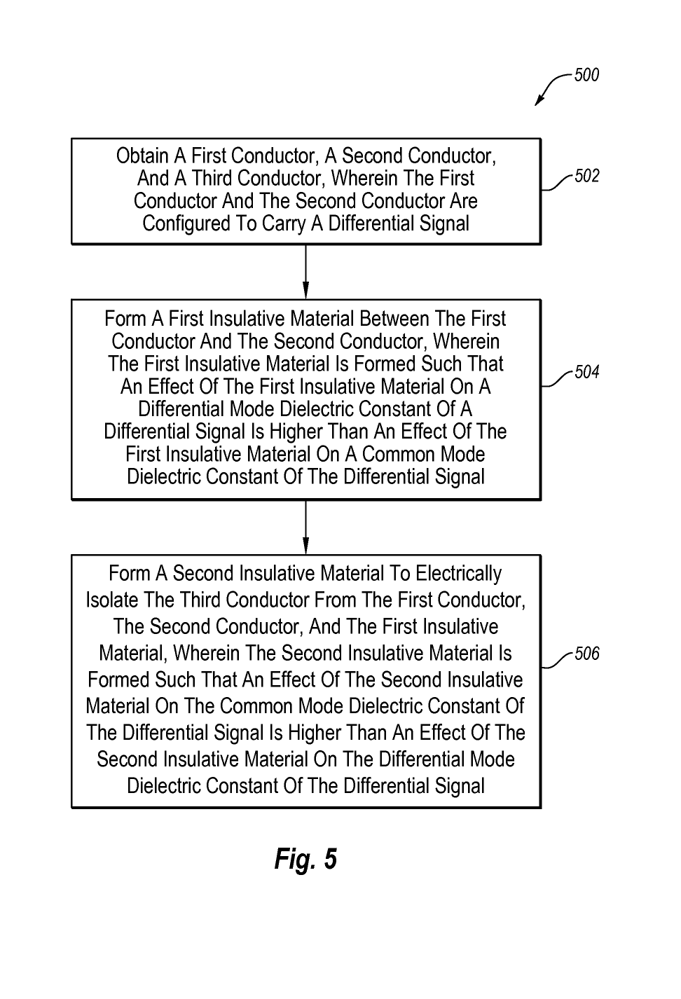

FIG. 5 is a flowchart of an example method 500 to form a differential signal transmission line, arranged in accordance with at least one embodiment described in the present disclosure. The method 500 may be implemented, in some embodiments, by designing, forming, and/or manufacturing a differential signal transmission line according to the principles described above with respect to the differential signal transmission lines 100, 200, 300, or 400 of FIGS. 1a, 2, 3, and 4, respectively. Although illustrated as discrete blocks, various blocks may be divided into additional blocks, combined into fewer blocks, or eliminated, depending on the target implementation.

The method 500 may begin at block 502, where a first conductor, a second conductor, and a third conductor may be obtained. In some embodiments, the first conductor and the second conductor may be configured to carry a differential signal. Alternately or additionally, the third conductor may be configured to carry a differential signal.

At block 504, a first insulative material may be formed between the first conductor and the second conductor. The first insulative material may be formed such that a primary effect of a first dielectric constant of the first insulative material on a differential mode dielectric constant of the differential signal is higher than a minor effect of the first dielectric constant of the first insulative material on a common mode dielectric constant of the differential signal.

At block 506, a second insulative material may be formed to electrically isolate the third conductor from the first conductor, the second conductor, and the first insulative material. The second insulative material may be formed such that an effect of a second dielectric constant of the second insulative material on the common mode dielectric constant of the differential signal is higher than an effect of the second dielectric constant of the second insulative material on the differential mode dielectric constant of the differential signal. In some embodiments, the common mode dielectric constant of the differential signal may be different from the differential mode dielectric constant of the differential signal.

In some embodiments, the difference between the common mode dielectric constant of the differential signal and the differential mode dielectric constant of the differential signal may be at least one, three, or six times greater than a greater of a typical variation of the common mode dielectric constant of the differential signal and a typical variation of the differential mode dielectric constant of the differential signal.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. For example, the method 500 may include forming the first conductor, the second conductor, and the third conductor. In these and other embodiments, the third conductor may be formed to surround the first conductor, the second conductor, the first insulative material, and the second insulative material.

In some embodiments, the method 500 may be performed using any method of construction that may result in a design as described in this disclosure. In some embodiments, the transmission line may be a differential signal cable. In these and other embodiments, the method 500 may be performed in a manner used to construct differential signal cables that may result in a design as described in this disclosure. For example, the first and second conductors may each be formed and covered separately with the first insulative material. Any process or procedure may be used to form and cover the first and second conductors with the first insulative material such that the first insulative material has a cross-section and is of a material so that a primary effect of a first dielectric constant of the first insulative material on a differential mode dielectric constant of the differential signal is higher than a minor effect of the first dielectric constant of the first insulative material on a common mode dielectric constant of the differential signal.

The first and second conductors covered with the first insulative material may be brought together and covered with the second insulative material. Any process or procedure may be used to form and cover the covered first and second conductors with the second insulative material such that second insulative material has a cross-section and is of a material so that a primary effect of a second dielectric constant of the second insulative material on the common mode dielectric constant of the differential signal is higher than a minor effect of the second dielectric constant of the second insulative material on the differential mode dielectric constant of the differential signal. Further process or procedures may be used to add additional materials to the cable.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A differential signal transmission line comprising:
a first conductor configured to carry a positive signal of a differential signal;
a second conductor configured to carry a negative signal of the differential signal;
a first insulative material positioned between the first conductor and the second conductor, the first insulative material having an effect on a differential mode dielectric constant of the differential signal that is greater than an effect on a common mode dielectric constant of the differential signal;
a third conductor; and
a second insulative material positioned to electrically isolate the third conductor from the first conductor, the second conductor, and the first insulative material, the second insulative material having an effect on the differential mode dielectric constant of the differential signal that is lower than an effect on the common mode dielectric constant of the differential signal.

2. The differential signal transmission line of claim 1, wherein the common mode dielectric constant is higher than the differential mode dielectric constant.

3. The differential signal transmission line of claim 1, wherein the common mode dielectric constant is lower than the differential mode dielectric constant.

4. The differential signal transmission line of claim 1, wherein the common mode dielectric constant is different than the differential mode dielectric constant.

5. The differential signal transmission line of claim 4, wherein the difference between the common mode dielectric constant and the differential mode dielectric constant is at least one, three, or six times greater than a greater of a typical variation of the common mode dielectric constant and a typical variation of the differential mode dielectric constant.

6. The differential signal transmission line of claim 1, wherein the first insulative material surrounds both the first conductor and the second conductor and the second insulative material surrounds the first conductor, the second conductor, and the first insulative material.

7. The differential signal transmission line of claim 1, wherein the third conductor surrounds the second insulative material.

8. The differential signal transmission line of claim 1, further comprising a fourth conductor, wherein the fourth conductor surrounds the first conductor, the second conductor, the third conductor, the first insulative material, and the second insulative material.

9. The differential signal transmission line of claim 1, wherein
the differential signal is a first differential signal, the differential mode dielectric constant is a first differential mode dielectric constant, and the common mode dielectric constant is a first common mode dielectric constant, and
the third conductor is configured to carry a positive signal of a second differential signal, the differential signal transmission line further comprising:
a fourth conductor configured to carry a negative signal of the second differential signal;
a third insulative material positioned between the third conductor and the fourth conductor, the third insulative material having an effect on a second differential mode dielectric constant of the second differential signal that is higher than an effect on a second common mode dielectric constant of the second differential signal;
the second insulative material further positioned to electrically isolate the fourth conductor and the third insulative material from the first conductor, the second conductor, and the first insulative material, the second insulative material further having an effect on the second differential mode dielectric constant of the second differential signal that is lower than an effect on the second common mode dielectric constant of the second differential signal,
wherein the second differential mode dielectric constant is different from the second common mode dielectric constant.

10. The differential signal transmission line of claim 9, wherein the second differential mode dielectric constant is approximately the same as the first differential mode dielectric constant.

11. A differential signal transmission line comprising:
a first conductor configured to carry a positive signal of a differential signal;
a second conductor configured to carry a negative signal of the differential signal;
a first insulative material positioned between the first conductor and the second conductor, the first insulative material having an effect on a differential mode dielectric constant of the differential signal that is higher than an effect on a common mode dielectric constant of the differential signal; and
a second insulative material that surrounds the first conductor, the second conductor, and the first insulative material, the second insulative material having an effect on the differential mode dielectric constant of the differential signal that is lower than an effect on the common mode dielectric constant of the differential signal.

12. The differential signal transmission line of claim 11, wherein the common mode dielectric constant is different than the differential mode dielectric constant.

13. The differential signal transmission line of claim 11, further comprising a third conductor, wherein the second insulative material electrically isolates the third conductor from the first and second conductors.

14. The differential signal transmission line of claim 13, wherein the third conductor surrounds the second insulative material, the first insulative material, the first conductor, and the second conductor.

15. The differential signal transmission line of claim 13, wherein
the differential signal is a first differential signal, the differential mode dielectric constant is a first differential mode dielectric constant, and the common mode dielectric constant is a first common mode dielectric constant, and
the third conductor is configured to carry a positive signal of a second differential signal, the differential signal transmission line further comprising:
a fourth conductor configured to carry a negative signal of the second differential signal;
a third insulative material positioned between the third conductor and the fourth conductor, the third insulative material having an effect on a second differential mode dielectric constant of the second differential signal that is higher than an effect on a second common mode dielectric constant of the second differential signal;
the second insulative material further configured to electrically isolates the fourth conductor and the third insulative material from the first conductor, the second conductor, and the first insulative material, the second insulative material further having an effect on the second differential mode dielectric constant of the second differential signal that is lower than an effect on the second common mode dielectric constant of the second differential signal,
wherein the second differential mode dielectric constant of the second differential signal is different from the second common mode dielectric constant of the second differential signal.

16. A method to form a differential signal transmission line, the method comprising:
obtaining a first conductor, a second conductor, and a third conductor, wherein the first conductor and the second conductor are configured to carry a differential signal;
forming a first insulative material between the first conductor and the second conductor, wherein the first insulative material is formed such that an effect of the first insulative material on a differential mode dielectric constant of the differential signal is higher than an effect of the first insulative material on a common mode dielectric constant of the differential signal; and
forming a second insulative material to electrically isolate the third conductor from the first conductor, the second conductor, and the first insulative material, wherein the second insulative material is formed such that an effect of the second insulative material on the common mode dielectric constant of the differential signal is higher than an effect of the second insulative material on the differential mode dielectric constant of the differential signal.

17. The method of claim 16, wherein the common mode dielectric constant of the differential signal is different from the differential mode dielectric constant of the differential signal.

18. The method of claim 17, wherein the difference between the common mode dielectric constant of the differential signal and the differential mode dielectric constant of the differential signal is at least one, three, or six times greater than a greater of a typical variation of the common mode dielectric constant of the differential signal and a typical variation of the differential mode dielectric constant of the differential signal.

19. The method of claim 16, further comprising forming the third conductor to surround the first conductor, the second conductor, the first insulative material, and the second insulative material.

20. The method of claim 16, wherein
the differential signal is a first differential signal, the differential mode dielectric constant is a first differential mode dielectric constant, and the common mode dielectric constant is a first common mode dielectric constant, and
the third conductor is configured to carry a positive signal of a second differential signal, wherein the method further comprises:
obtaining a fourth conductor; and
forming a third insulative material between the third conductor and the fourth conductor, the third insulative material formed such that an effect of the third insulative material on a second differential mode dielectric constant of a second differential signal is higher than an effect of the third insulative material on a second common mode dielectric constant of the second differential signal,
wherein the second insulative material is formed such that an effect of the second insulative material on the second differential mode dielectric constant of the second differential signal is lower than an effect of the second insulative material on the second common mode dielectric constant of the second differential signal,
wherein the first common mode dielectric constant of the first differential signal is different from the first differential mode dielectric constant of the first differential signal, and the second common mode dielectric constant of the second differential signal is different from the second differential mode dielectric constant of the second differential signal.
